(19) United States
(12) Patent Application Publication
(10) Pub. No.: US 2011/0088564 A1
(43) Pub. Date: Apr. 21, 2011

(54) Egg Cooker Device

(76) Inventor: Stuart Bonsell, London (GB)

(21) Appl. No.: 12/582,973

(22) Filed: Oct. 21, 2009

(51) Int. Cl. A47J 29/04

(52) U.S. Cl. 99/336; 99/443 R

(57) ABSTRACT

An egg cooker device comprises a water container 1 and an electric heating element, the container including a support platform 7 capable of lowering an egg into a body of water in the container 1, an electric motor 13 arranged for moving the platform 7 from a rest position at an open top of the container to an egg heating position within the container, a timer device connected to the motor such that the platform will remain in the egg heating position for a predetermined time interval, in which the support platform 7 includes a drive means 3 linked by a magnetic coupling to a drive source 12 located outside the container 1. This construction uses a magnetic coupling to get a drive from the motor 13 shaft through the wall of the container, it thus avoids a need to provide a water sealed opening for the shaft in the container 1 wall.

### BACKGROUND OF THE INVENTION

This invention relates to an egg cooker device. There have been many different constructions proposed for carrying out this relatively simple household task. One particular device provides a wire basket by which the egg is supported in a bath of boiling water and a mechanical lift arrangement is then actuated after a required time interval to raise the egg out of the water. This arrangement is capable of doing a satisfactory job but it is not generally able to measure a precise time interval and accurate timing would be preferred by many consumers who require carefully soft boiled eggs.

An egg cooker with an accurately adjustable timer is shown in patent specification No. GB2423007. The specification discloses an automatic egg boiler comprising a water container, an electric heating element, a drive means able to move an egg to an open top of the container when actuated and an electronic timer. This egg boiler is thus able to work on its own without needing to be closely supervised and it will move the cooked egg to an open top of the container at the end of its working cycle. The egg boiler is thus capable of being placed on a kitchen working surface or table and it will deliver a boiled egg of the required hardness which a consumer can immediately transfer to their eating plate.

The drive means which is required to move the egg to the open top of the container is required to operate below the surface level of the heated water in the container and it is not easy to provide a mechanical drive means which will work reliably under these conditions. It would be possible to provide a waterproof seal to enable a motor shaft to pass through a wall of the container but any such seal is likely to require regular maintenance and this would eventually cause a problem in a small domestic appliance which might be expected to be used every day over a lifetime of several years.

### SUMMARY OF THE INVENTION

The present invention provides a drive means for the egg to be raised to the top of the container. The drive means in operation is able to raise the cooked egg to the container top and this is done without impairing the water sealing effectiveness of the container wall.

According to the invention, there is provided an egg cooker device comprising a water container, an electric heating element, an electronic timer and a drive means able to move an egg to an open top of the container when actuated, in which the drive means is linked by a magnetic coupling to a drive source located outside the container. Of course, the container is intended to be made of a non magnetic material.

In one embodiment, the drive source is a rotor carrying one or more permanent magnet bodies where the rotor is driven by a motor. The motor may be provided with a drive shaft carrying a square plug which engages with a corresponding socket on the rotor.

In another embodiment, the drive source is a rotating magnetic field which is generated from static magnetic poles to which suitable electric pulses are applied.

The drive means inside the container may be a drive disc supporting one or more permanent magnets. Preferably, the drive disc supports two bar magnets which are curved in shape so as to be able to lie along the circumference of a circle. The drive disc may be arranged to completely enclose the relevant permanent magnets. The drive disc may be located coaxially with a drive screw so that a rotational movement of the disc will cause the screw to be rotated. A platform for supporting an egg may be mounted on a nut which is coupled to the drive screw such that rotation of the screw will cause the platform to be raised or lowered. The platform may be provided with radially aligned slots which are able to slide along vertical ribs in the walls of the container. The ribs thus serve to prevent any rotation of the egg platform and the nut when the drive screw is turned.

In accord with another embodiment of the invention.

Additional objects and advantages of the invention will become apparent to those skilled in the art upon reference to the detailed description taken in conjunction with the provided figures.

### BRIEF DESCRIPTION OF THE DRAWINGS

By way of an example, a particular embodiment of the invention will now be described with reference to the accompanying drawings.

FIG. 1 is a partial cross-sectional view of the egg cooker device.

FIG. 2 is a detail showing a rotor member forming part of the device drive means.

FIG. 3 is a detail showing the device drive means and a magnetic coupling which enables a motor drive to be applied within a container.

FIG. 4 is a different partial cross sectional view.

FIG. 5 shows how the water container is able to be supported between two half shells to form a thermally insulated enclosure.

FIG. 6 depicts the insulated enclosure being positioned on a base unit which also provides a connection to a mains electric power supply.

FIG. 7 is a rear view of the enclosure being positioned on the base unit.

FIG. 8 is a front view of the egg cooker device placed in its working position on the base unit.

### DETAILED DESCRIPTION OF THE PREFERRED EMBODIMENTS

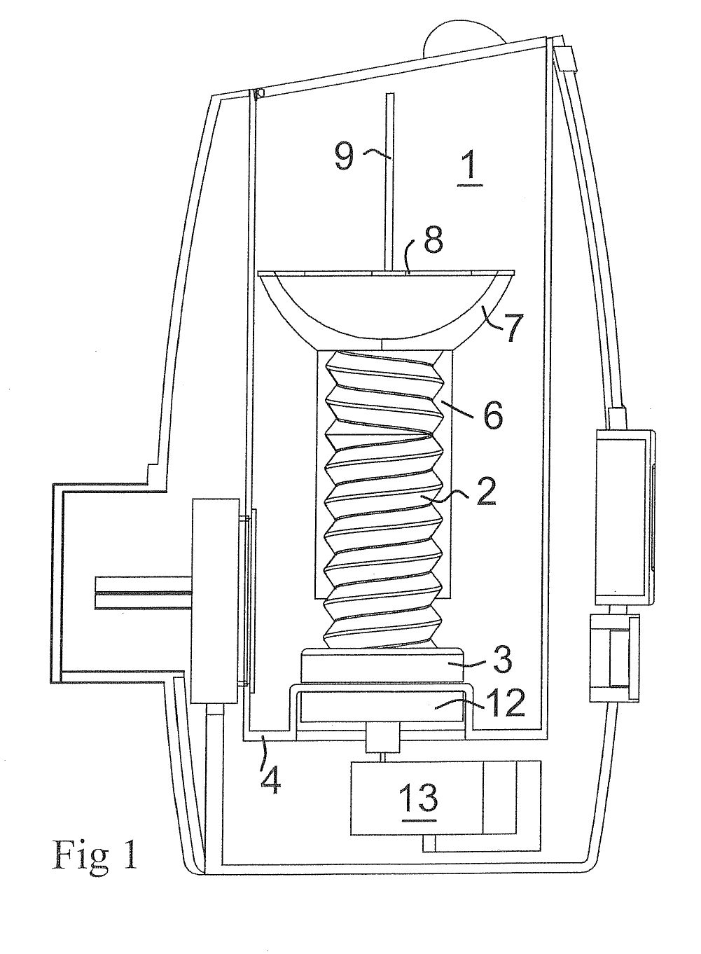

As depicted in FIG. 1, the egg cooker device includes a water container 1 of a generally cylindrical shape which encloses an electric heating element (not shown) and a drive means formed by a drive screw 2 which is provided at a lower end with a drive disc 3. The drive disc 3 lies in contact with a base wall 4 of the container. The drive screw 2 is coupled to a cylindrical nut 6 which carries an egg support platform 7 at its upper end. A rotation of the drive screw 2 with respect to the nut 6 will thus cause the nut 6 to be moved along the longitudinal axis of the screw 2. A suitable rotation of the drive screw 2 will serve to move the egg support platform 7 up to the top of the container 1 or alternatively will allow the platform 7 to be lowered until the length of the nut 6 supporting the platform 7 is completely accommodated on the screw 2.

The egg support platform 7 is provided with slots 8 which are arranged to slide along vertical ribs 9 located on an inner wall of the container 1. The vertical ribs 9 act to prevent any rotation of the nut 6 and the egg support platform 7 when the drive screw 2 is rotated. The vertical ribs 9 also serve to hold the platform 7 centrally within the water container 1 so that the upper part of the drive screw 2 is prevented from being tilted with respect to the container 1 axis.

The drive disc 3 on the inside of the container 1 is provided with two internally mounted permanent magnet bodies. These bodies are bar magnets which are curved in shape such that they will be able to lie along the circumference of a circle. The magnet bodies are completely sealed within the outline of the drive disc 3.

FIG. 1 also shows a rotor 12 which is of a similar construction to that of the drive disc 3. The rotor 12 is intended to be driven by an electric motor 13 and gear assembly mounted beneath the container 1 and consequently the rotor 12 is provided with a central shaft socket into which a shaped end of a motor drive shaft is engaged. The motor drive shaft is thus given a positive mechanical linkage for driving the rotor 12.

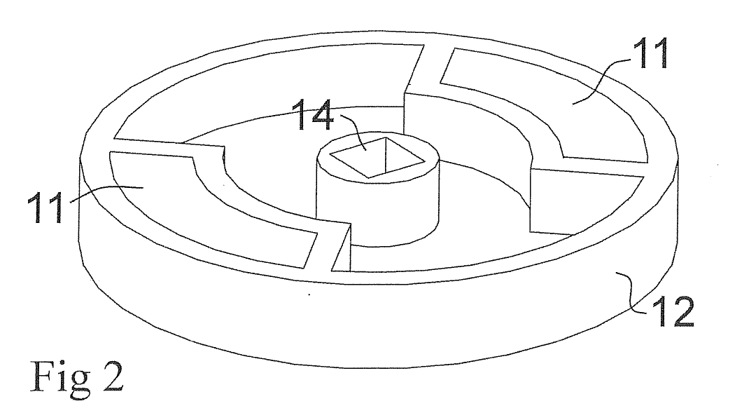

FIG. 2 shows the rotor 12 on a larger scale, this is seen to support two bar magnet bodies 11 that are sealed within the outline of the rotor. The bar magnet bodies are of curved shape and they are positioned so as to lie along the circumference of a circle. At its centre, the rotor 12 member is provided with the square socket 14 which enables the member to be engaged with a corresponding plug end on a drive shaft. The drive shaft is coupled to the motor 13 and gear box assembly.

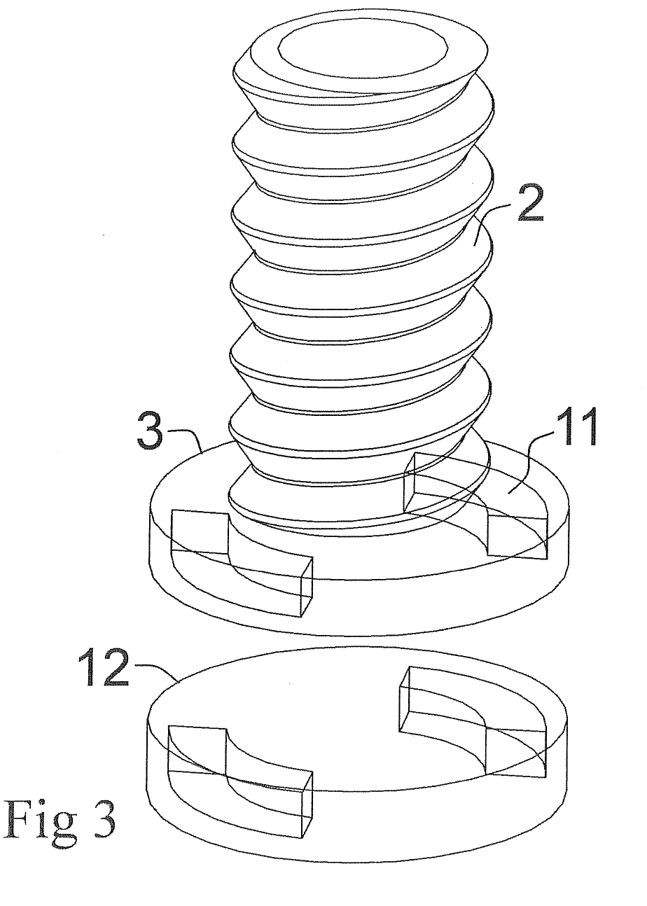

FIG. 3 shows a detail of the rotor 12 which is driven by the motor and the drive disc 3 which is coupled magnetically to the rotor. As already mentioned, the drive disc 3 is mounted on a common axis with the drive screw 2 and the disc 3 similarly includes the magnetic bodies 11.

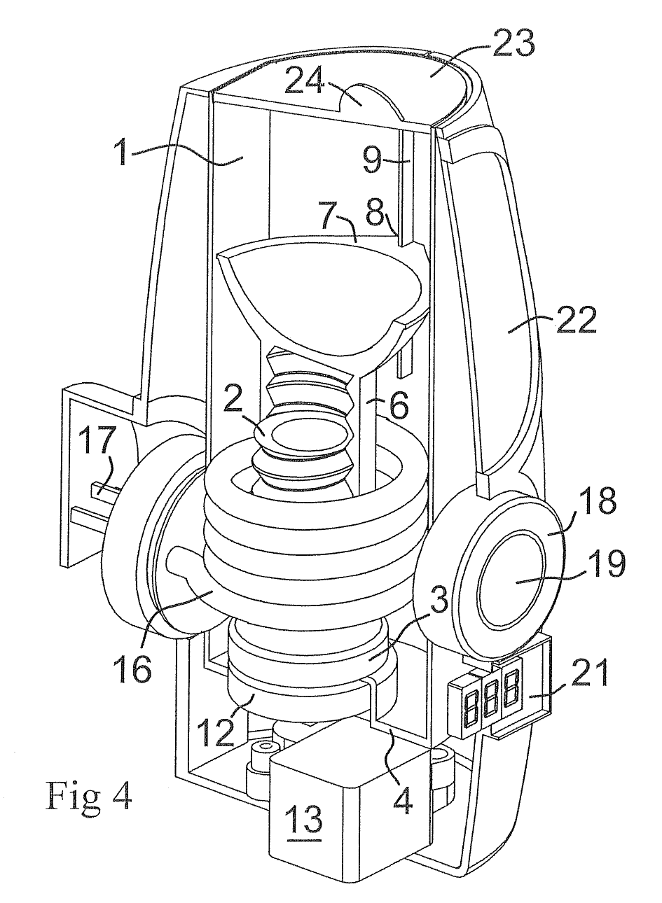

FIG. 4 is a different cross-sectional view showing an electrical heating element 16 positioned in the water container 1 in a location surrounding the drive screw 2. The ends of the heating element 16 pass through a watertight gland in the container wall and they terminate in a coupling 17 for an electrical connector. Beneath the water container 1, the motor and gear assembly is provided for driving the rotor 12. The rotor 12 is seen to be positioned within a recess which has been formed in the base wall 4 of the container 1. This recess serves to centralise the rotor 12 so that it will be protected against any risk of becoming displaced with respect to the water container when the cooker device is in operation. The drive disc 3 is located immediately above this recess so that it is spaced by only a short distance from the rotor. This provision ensures that there is only a minimal attenuation of the magnetic forces providing the drive means from the rotor 12 to the disc 2.

FIG. 4 also shows an electronic timer setting dial 18, a ‘start’ button 19 and a timer interval display 21 for the cooker device. A transparent window 22 for possible observation of the egg during the cooking process is positioned above the dial 18.

The egg support platform 7 has been depicted in a partly cut-away view and the platform is seen to be mounted on the cylindrical nut 6 which is engaged with the drive screw 2. The egg support platform 7 is of a concave shape so that it will form a secure seat for an egg, when present. At the edge of the platform 7, the slot 8 which engages with the vertical rib 9 on the container wall is also visible. At the top of the container, there is a hinged lid 23 with a raised finger grip 24. When the egg support platform 7 is in the elevated position, an egg on the platform will tend to lift this lid 23 so that a user of the cooker will be made aware that the working cycle has been completed. Additionally, an audible signal will sound to indicate that the end of the timed cooking period has been reached.

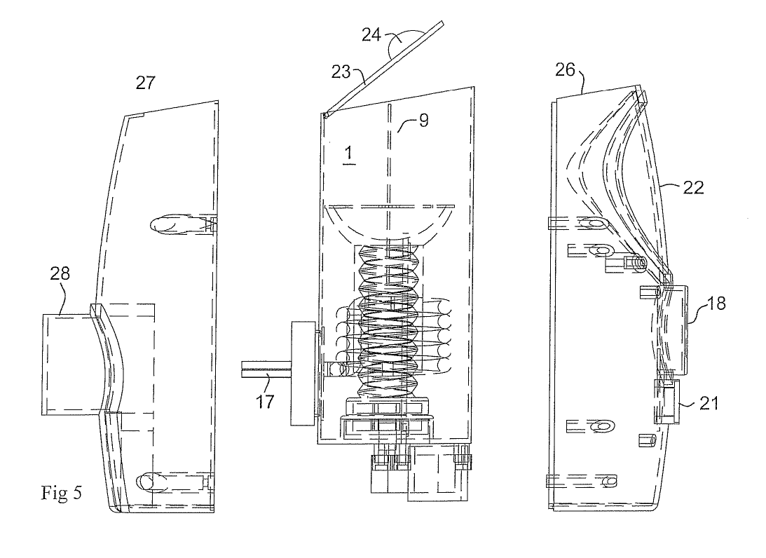

FIG. 5 shows an exploded view of the FIG. 4 construction. The water container 1 is seen to be supported between a front half shell 26 and a rear half shell 27 such that when the container 1 and the half shells are assembled together a rigid thermally insulated structure will be formed. The front half of the shell 26 supports the electronic timer setting dial 18, the ‘start’ button 18 and the timer interval display 21. A printed circuit board (not shown) is mounted immediately behind the dial 18 and this board supports the dial and the display assembly. An audio signal device is also mounted on the board, together with a water temperature sensor for the water in the container and an energy controller for the heating element 16.

The front half of the shell 26 also has supports for the transparent window 22.

In FIG. 5, the hinged lid 23 of the container 1 is seen in an open condition. The positioning of the lid 23 is intended to protect the user from a risk of scalding from an unexpected escape of hot steam. The location of the finger grip 24 on the lid is arranged to discourage an attempt to open the lid from the window 22 side of the device so that any escape of steam will not touch the hand of the user. The finger grip 24 is positioned to be more readily gripped from the rear of the unit so that the hand of the user will be moved out of the direct route of the steam from the lid 23 opening. The finger grip 24 is able to be grasped by the user's thumb and forefinger.

FIG. 5 shows that the rear half shell 27 includes a cover 28 which fits over the electrical coupling 17 pins as they emerge from the gland in the container 1 wall. The coupling 17 pins are therefore screened from coming into contact with the hand of the user and also from any water spillage or accidental electrical discharge. The coupling pins 17 are able to make contact with a suitably protected electrical socket which is mounted on a base unit which is provided for the cooker device.

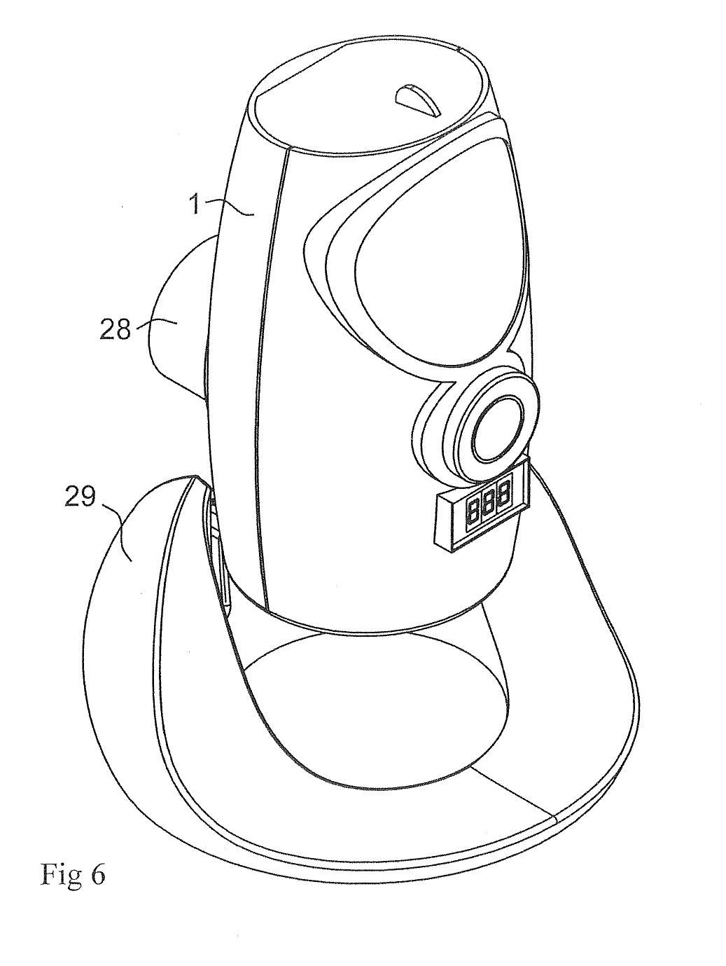

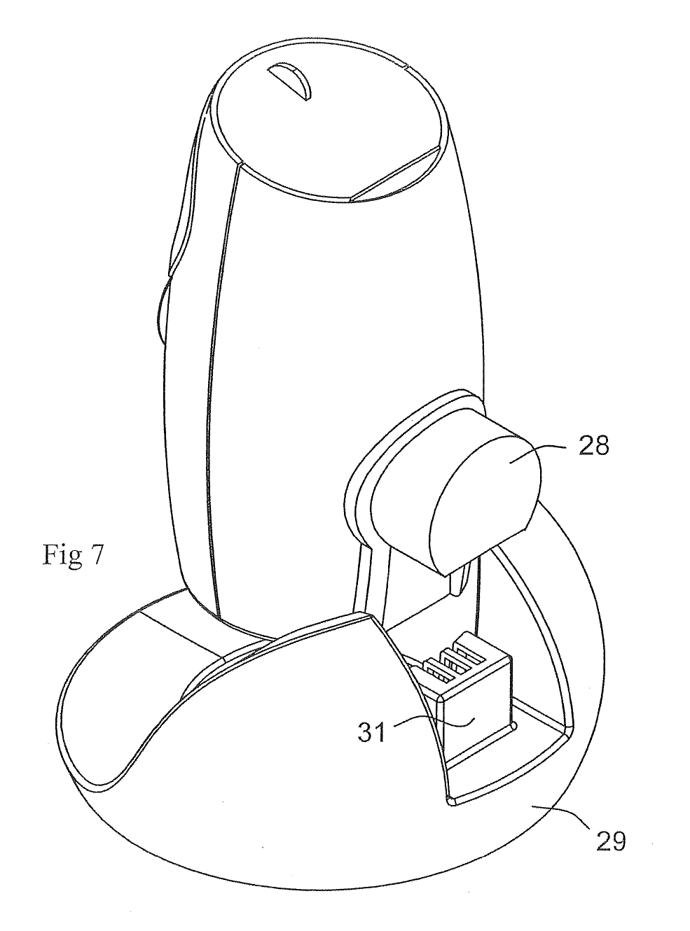

FIG. 6 shows the water container 1 component of the cooker device being placed on its baser unit 29. FIG. 7 is a similar view from the rear side. The base unit 29 includes a power lead (not shown) and plug for attachment to a mains electric power supply. The base unit 29 thus provides a safe way of connecting the water container 1 and the associated electrical components to the power supply. The cover 28 which encloses the coupling 17 pins on the rear side of the cooker device will be moved adjacent a screened socket 31 on the base unit 29 so that the coupling pins will be able to make contact with suitable connectors which are located within the screened socket 31. The electrical connections are therefore able to be made under safe conditions without any bare metal parts becoming exposed to unwanted contacts.

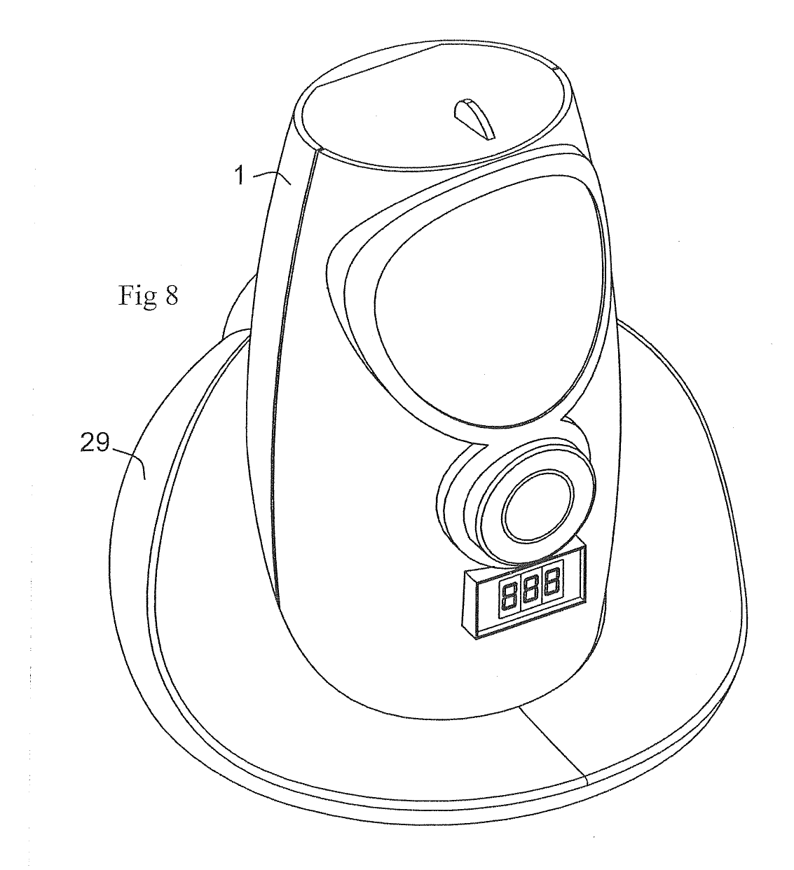

FIG. 8 shows the water container 1 component positioned in its normal attitude on the base unit 29 and this is the usual appearance of the egg cooker device when made ready for use.

In operation of the egg cooker device, a user will first ensure that there is the correct level of water present in the water container 1 and then the user will adjust the timer dial 18 to set the timer interval to the particular duration of the cooking process that is required. The set interval will be shown on the timer interval display device 21. This action will also serve to bring the egg support platform 7 up to the top of the water container 1. The user will then lift the container lid 23 and place an egg on the support platform 7. The user will press the ‘start’ button 19 to initiate the cooking operation. The electric heating element 16 will be energized, the water will be heated to a predetermined temperature and the support platform 7 will move to lower the egg into the water. The cooking process can be observed through the transparent window 22 and the numerals on the timer interval display 21 will count down to the end of the set timed period. Upon completion of the cooking period, the power supply to the heating element 16 will be interrupted and the support platform 7 will be raised to bring the egg out of the water and up to the top of the water container 1. The audio signal will sound to indicate the end of the cooking period. The container lid 23 will be pushed up by the egg so this may conveniently be removed. The egg may then be readily transferred to an eating plate to provide an immediate light meal for the user. The cooker device is able to be reused straight away for a further egg with any necessary adjustment being made to the cooking time.

The egg cooker device of the invention has been found to be reliable in operation and it is able to provide a cooked egg that can be accurately and consistently timed to suit the preference of the user. The provision of the magnetic coupling to a drive means located inside the water container ensures that there is very little risk of any water leakage occurring in the container base.

The foregoing description of an embodiment of the invention has been given by way of example only and a number of modifications may be made without departing from the scope of the invention as defined in the appended claims. For instance, instead of all the working parts of the egg cooker being located in the water container component, some of these working parts could conveniently be positioned on the base unit. The egg cooker, if required, could be arranged to cook two or more eggs with a suitable modification of the egg support platform.

What is claimed is:

1. An egg cooker device comprising a water container and an electric heating element, the container including a support platform capable of lowering an egg when present into a body of water when present in the container, an electric motor arranged for moving the said platform from a rest position at an open top of the container to an egg heating position within the container, a timer device connected to the motor such that the platform movement will allow the platform to remain in the egg heating position for a predetermined time interval, in which the support platform includes a drive means linked by a magnetic coupling to a drive source located outside the container.

2. A device as claimed in claim 1, wherein:
the drive source is a rotor carrying one or more permanent magnet bodies where the rotor is driven by the said motor.

3. A device as claimed in claim 2, wherein:
the motor is provided with a drive shaft carrying a drive plug which engages with a corresponding socket on the rotor.

4. A device as claimed in claim 1, wherein:
the drive source is a rotating magnetic field which is generated from static magnetic poles to which suitable electric pulses are applied.

5. A device as claimed in claim 1, wherein:
the drive means inside the container is a drive disc supporting one or more permanent magnets.

6. A device as claimed in claim 5, wherein:
the drive disc supports one or more bar magnets which are curved in shape so as to be able to lie along the circumference of a circle.

7. A device as claimed in claim 6, wherein:
the drive disc is arranged to completely enclose the relevant permanent magnets.

8. A device as claimed in claim 7, in which the drive disc is located coaxially with a drive screw so that rotational movement of the disc will cause the screw to be rotated.

9. A device as claimed in claim 8, in which the drive screw is coupled by a nut to said support platform such that the rotation of the screw will cause the platform to be raised or lowered within the container.

10. A device as claimed in claim 9, wherein:
the platform includes stop means arranged to prevent rotation of said platform with respect to the water container.

11. A device as claimed in claim 10, wherein:
the stop means comprises radially aligned slots located on the said platform together with ribs on a wall of the container.
